(19) United States
(12) Patent Application Publication
(10) Pub. No.: US 2003/0043454 A1
(43) Pub. Date: Mar. 6, 2003

(54) Optical transmission apparatus, semiconductor laser device for use in optical transmission apparatus, and method for manufacturing semiconductor laser device

(76) Inventors: YoungDuk Yoon, Tokyo (JP); Takayuki Okazaki, Tokyo (JP); Sakiko Sugihara, Tokyo (JP)

Correspondence Address: COUDERT BROTHERS LLP, Third Floor, 600 Beach Street, San Francisco, CA, 94109, US

(21) Appl. No.: 10/227,020

(22) Filed: Aug. 21, 2002

(30) Foreign Application Priority Data
Aug. 23, 2001 (JP) 2001-253,100

(51) Int. Cl. H04B 10/12

(52) U.S. Cl. 359/341.3

(57) ABSTRACT

Disclosed are semiconductor laser diodes and laser diode modules for reducing noise in EDFA and TDFA fiber amplifiers, to thereby increase signal bandwidth. A major source of noise is identified as being signal light that is inadvertently coupled from the fiber amplifier to the laser diode, and then returned back to the fiber amplifier as noise. In one aspect of the present invention, the back facet of the laser diode is constructed to achieve a reflectivity to the signal light of 40% or less. In another aspect, an anti-reflective coating is provide on the coupling fiber to the laser diode. A reduction of at least 17 dB in the returned signal is achieved by the present invention.

### CROSS REFERENCE TO RELATED APPLICATION

This application is based on Japanese patent application 2001-253100, filed on Aug. 23, 2001, the whole contents of which are incorporated herein by reference.

### FIELD OF THE INVENTION

The present invention relates to an optical transmission apparatus, and more particularly to an optical transmission apparatus which is equipped with an optical fiber amplifier and which is suitable for use in wide-band optical communication. Furthermore, this invention also relates to an excitation semiconductor laser device for use in the optical transmission apparatus, as well as to a method for manufacturing the excitation semiconductor laser device.

### BACKGROUND OF THE INVENTION

As one method for realizing wide-band optical communication, WDM (Wavelength Division Multiplexing) communication systems have been attracting the attention of more and more people. Such a communication system may comprise, for example, an EDFA (Erbium Doped Fiber Amplifier) and/or a TDFA (Thulium Doped Fiber Amplifier) disposed in part of the optical communication lines. In use, a pumping laser beam is introduced from a pumping laser module to the EDFA/TDFA, so that an optical signal transmitted from an optical signal source through an optical communication line may be amplified within the EDFA/TDFA. Then, the amplified optical signal is further transmitted in the downstream direction. On the other hand, in the pumping laser module, a semiconductor laser device is used as a light source for producing the pumping laser beam. For example, in an optical transmission system for transmitting light having a wavelength of 1.55 μm, the pumping laser beam has a wavelength which is generally within 30 nm of 0.98 μm for an EDFA, and within 60 nm of 1.06 μm for a TDFA.

However, although the above-described optical transmission system is durable for actual use in the case where the optical transmission rate is slow, an increased transmission rate will undesirably increase the noise in the optical transmission system, thus making it difficult to ensure a sufficient optical transmission quality.

### SUMMARY OF THE INVENTION

Accordingly, an object of the present invention is to provide improved optical transmission apparatuses capable of ensuring a high transmission quality even at high transmission rates. Another object of the present invention is to provide improved semiconductor laser devices for use in the optical transmission apparatuses. In addition, a further object of the present invention is to provide a method for manufacturing the semiconductor laser device.

In making their invention, the inventors have recognized that, in practice, a part of the optical signal will enter the front facet of the pumping laser beam source, propagate to the back facet of the source where a high reflectivity (HR) film (coating) is present, then reflect off of the HR film back toward the front facet, and then return back to the optical fiber amplifier. The inventors have discovered that such a returning light will often cause noise in the fiber amplifier. The present invention is focused on reducing the intensity of this returned light.

According to one aspect of the present invention, there is provided an optical transmission apparatus for amplifying an optical signal having a first wavelength, as measured in free-space, with the optical transmission apparatus comprising an optical fiber amplifier having first end to receive the optical signal and a second end to output an amplified version of the optical signal, and further comprising a laser pumping light source adapted to generate a pumping laser beam having a second wavelength, as measured in free-space, which is different from the first wavelength. The pumping laser beam is optically coupled to at least one of the ends of the optical fiber amplifier, and comprises a front facet to output the pumping laser beam, a rear facet, a resonator cavity disposed between the front and rear facets, and a high-reflectivity film formed on the rear face. The high-reflectivity film has a first reflectance for light of the first wavelength and a second reflectance for light of the second wavelength, wherein the first reflectance of the high-reflectivity film has a value of 40% or less. In preferred embodiments of this aspect, the second reflectance of the high-reflectivity film has a value of 85% or more.

According to another aspect of the present invention, there is provided an optical transmission apparatus for amplifying an optical signal having a first wavelength, as measured in free-space, with the optical transmission apparatus comprising an optical fiber amplifier having first end to receive the optical signal and a second end to output an amplified version of the optical signal, and further comprising a laser pumping light source adapted to generate a pumping laser beam having a second wavelength, as measured in free-space, which is different from the first wavelength. The pumping laser beam is optically coupled to at least one of the ends of the optical fiber amplifier, and comprises a front facet to output the pumping laser beam, a rear facet, a resonator cavity disposed between the front and rear facets, a low-reflectivity film disposed at the front facet, and a high-reflectivity film formed on the rear face. The high-reflectivity film has a first reflectance for light of the first wavelength and a second reflectance for light of the second wavelength, and the low-reflectivity film has a first reflectance for light of the first wavelength and a second reflectance for light of the second wavelength. An optical fiber is further provided for conveying pumping light from the laser pumping light source to the optical fiber amplifier. The optical fiber has an end disposed at the front facet of the laser pumping light source. The fiber amplifier directs a first amount of the optical signal having a power P₀ through the optical fiber toward the laser pumping light source, and a second amount of the optical signal having power P_{R} is returned back through the optical fiber toward the fiber amplifier, the second amount being generated in part from the films of the laser pumping light source, and being reduced by at least 17 decibels with respect to P₀.

According to yet a further aspect of the present invention, there are provided semiconductor laser devices for use as a pumping laser beam sources in the above-described light transmitting apparatuses.

According to a still further aspect of the present invention, there is provided a method of manufacturing a semiconductor laser device for introducing a pumping laser beam having a second wavelength, as measured in free space, into an optical fiber amplifier capable of amplifying an optical signal having a first wavelength, as measured in free space. The first and second wavelengths are different. The methods comprise the step of forming a semiconductor laser laminated structure defining a light-emitting end face and a rear face, with the laminated structure being capable of effecting a stimulated emission by injecting carriers and emitting from the light-emitting end face the pumping laser beam having the second wavelength. The method further comprises forming a high-reflectivity film on the rear face having a first reflectance for light of the first wavelength and a second reflectance for light of the second wavelength the first reflectance of the high-reflectivity film having a value of 40% or less. In preferred embodiments of this aspect, the second reflectance of the high-reflectivity film has a value of 85% or more.

As described in the above, by reducing the intensity of the optical signal which returns to the optical fiber amplifier after being reflected on the pumping laser module, it becomes possible to reduce the noise caused by such returning light, thereby making it possible to ensure high transmission quality. In this way, it becomes possible to perform the desired wideband optical transmission.

### BRIEF DESCRIPTION OF THE DRAWINGS

FIG. 1 is an explanatory view showing an optical transmission apparatus formed according to an exemplary embodiment of the present invention.

FIG. 2 is a cross sectional view showing a pumping laser module used in the optical transmission apparatus formed according to the exemplary embodiment of the present invention.

FIG. 3A is a perspective view showing a semiconductor laser device formed according to one exemplary embodiment of the present invention.

FIG. 3B is a side view showing a semiconductor laser device formed according to the exemplary embodiment of the present invention.

FIG. 4A is a graph showing how the reflectance of a low-reflectivity film (which is used in the semiconductor laser device formed according to one embodiment of the present invention) depends upon the wavelength of light, as compared with the reflectance of a conventional low-reflectivity film.

FIG. 4B is a graph showing how the reflectance of a high-reflectivity film according to the present invention depends upon the wavelength of light, as compared with the reflectance of a conventional high-reflectivity film.

FIG. 5A is a graph showing how the refractive index of each low-reflectivity film (which is used in the semiconductor laser device formed according to the embodiment of the present invention) depends upon the wavelength of light.

FIG. 5B is a graph showing how the refractive index of each high-reflectivity film (which is used in the semiconductor laser device formed according to the embodiment of the present invention) depends upon the wavelength of light.

FIG. 6 is a graph showing how the reflectance of a low-reflectivity film depends upon the wavelength of light, representing three different cases where a low-reflectivity film used in the semiconductor laser device (formed according to an embodiment of the present invention) is a three-layer structure, a five-layer structure, or an eight-layer structure.

FIG. 7A and FIG. 7B are graphs showing how the reflectance depends upon the wavelength of light in the case where the low-reflectivity film of a semiconductor laser device (formed according to an embodiment of the present invention) includes a SiNₓ film and a SiO₂ film.

FIG. 8 is a graph showing how the reflectance depends upon the wavelength of light, when changing the number of layers and the type of dielectric material forming a low-reflectivity film (which is used in a semiconductor laser device formed according to the embodiment of the present invention).

FIG. 9 is a cross-section of an optical fiber which couples light from the pumping laser device, wherein the optical fiber comprises an anti-reflective coating according to the present invention.

FIG. 10 is a schematic diagram of a test system which may be used to measure the level of return light achieved by the present invention.

### DESCRIPTION OF THE PREFERRED EMBODIMENTS

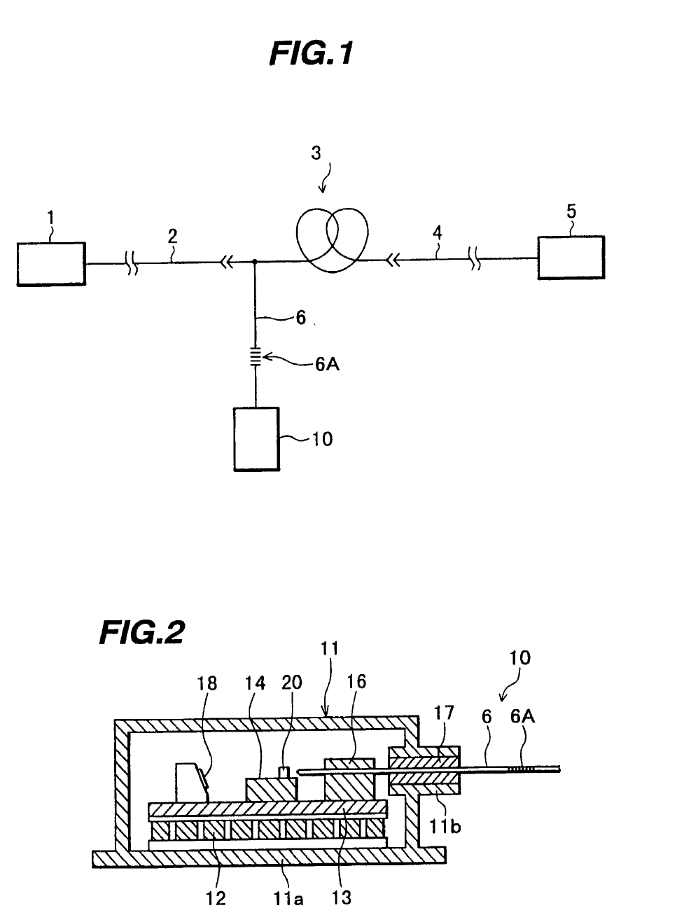

FIG. 1 is an explanatory view showing an exemplary optical transmission apparatus formed according to one embodiment of the present invention. As shown in the drawing, an optical signal source 1 is provided to emit an optical signal beam which has been subjected to a wavelength division multiplexing process and has a wavelength of 1.55 μm, as measured in free space. The optical signal beam emitted from the optical signal source 1 is transmitted into a transmitter-side optical fiber 2. A fiber amplifier 3, such as an EDFA or TDFA for example, is optically coupled at the end position on the downstream side of the transmitter-side optical fiber 2. A pumping laser beam emitted from a pumping laser module 10 is introduced into the fiber amplifier 3 through an optical fiber 6. In this way, the optical signal can be amplified by virtue of the pumping laser beam. As seen in FIG. 1, fiber amplifier 3 has two ends. While FIG. 1 shows optical fiber 6 being coupled to the signal input end of fiber amplifier 3, optical fiber 6 may also be coupled to the signal output end of fiber amplifier 3. In other words, the pumping light may be coupled to fiber amplifier 3 through either end of fiber amplifier 3. (Coupling of pumping light to both ends of an EDFA is also possible, but rarely done.)

A receiver-side optical fiber 4 is optically coupled to the output end (the emission side) of the fiber amplifier 3. The optical signal amplified in the fiber amplifier 3 enters the receiver-side optical fiber and is then transmitted through the fiber. Further, an optical receiver 5 is optically coupled at an end position on the downstream side of the receiver-side optical fiber 4. The optical receiver 5 is provided to receive an optical signal transmitted through the receiver-side optical fiber 4 and to preferably separate the optical signal subjected to the wavelength division multiplexing process, so as to separate (in accordance with wavelength) the optical signal into different components having different wavelengths.

Furthermore, in the optical fiber 6 for introducing the pumping laser beam into the fiber amplifier 3, there is formed a fiber Bragg grating 6A, which is one exemplary embodiment of a wavelength selector. The Bragg grating is designed to reflect light with a wavelength in the pumping band of the fiber amplifier (e.g., within 30 nm of 0.98 μm for EDFA, and within 60 nm of 1.06 μm for TDFA). The wavelength of the pumping laser beam is in a reflecting range of the fiber Bragg grating 6A, and accordingly, the pumping laser beam emitted from the pumping laser module 10 can be fed back to the pumping laser module 10 by virtue of the fiber Bragg grating 6A. In this way, the oscillation wavelength of the semiconductor laser device in the pumping laser module 10 can be made to be in the wavelength pumping band of the fiber amplifier, thereby ensuring a desired light beam output which is stable in time.

The wavelength values presented herein are given for the light as measured in free space. The pumping band of an EDFA generally encompasses wavelengths within 30 nm of 0.98 μm, and the pumping band of a TDFA generally encompasses wavelengths within 60 nm of 1.06 μm. The optical signals being amplified by EDFAs and TDFAs generally have wavelengths that are within 100 nm Of 1.55 μm, which we call the signal band of the fiber amplifier. The ratio of the wavelength of the optical signal to the wavelength of pumping light is generally at least 1.35 for TDFAs, and 1.45 for EDFAs. The difference between wavelengths is at least 300 nm, and usually at least 400 nm.

FIG. 2 is a cross-sectional view showing an exemplary pumping laser module 10 for use in the optical transmission apparatus formed according to the embodiment of FIG. 1. As shown in the drawing, the pumping laser module 10 comprises a package 11 having a bottom plate 11 a on which a Peltier module 12 is mounted. Further, a base plate 13 made of Kovar alloy is attached on the Peltier module 12.

A semiconductor laser device 20 is disposed on the base plate 13 via a chip carrier 14. A light-incident end face of the optical fiber 6 is positioned so as to face the light-emitting end face of the semiconductor laser device 20, in a manner such that the two end faces are optically coupled to each other. In preferred embodiments, the light-incident end face of the optical fiber 6 is formed to have a wedge-like shape, thereby ensuring a high optical coupling efficiency. In this way, since it is not necessary to utilize a converging lens or the like, the number of parts for forming the module can be reduced, thereby making it possible to reduce the production costs. Specifically, the optical fiber 6 is fixed, at one portion close to its light-incident end face, to the base plate 13 by virtue of a fiber fixing member 16. Then, the optical fiber 6 is led out of the package 11 by way of a cylindrical hole 11b formed through the package 11. In particular, a sleeve 17 is inserted into the cylindrical hole 11b, thus ensuring air tightness for the package 11 when the optical fiber passes therethrough.

Finally, a photodiode 18 is disposed to face toward one surface of the semiconductor laser device 20 opposite to the light-emitting face. By virtue of the photodiode 18, it is possible to monitor the strength of the laser beam emitted from the rear face of the semiconductor laser device 20.

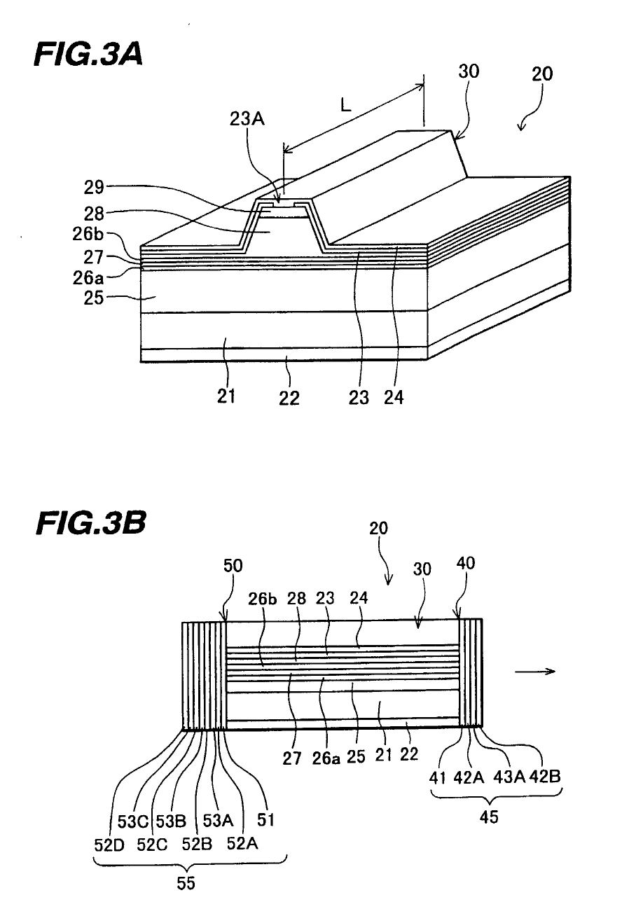

FIG. 3A is a perspective view illustrating an exemplary embodiment for semiconductor laser device 20 shown in FIG. 2. As shown in the drawing, the laser device comprises a substrate 21 which in turn comprises n-type GaAs material. A lower clad layer 25 comprising n-type Al_{0.3}Ga_{0.7}As (doped with Si) is formed on the surface of the substrate 21. Specifically, the lower clad layer 25 has a thickness of 4 μm, with the Si concentration being 3×10¹⁷ cm⁻³. Further, a lower separated confinement hetero (SCH) layer 26a comprising undoped Al_{0.2}Ga_{0.8}As is formed on the lower clad layer 25. The thickness of the lower SCH layer 26a is preferably 50 nm.

Formed on the lower SCH layer 26a is an active layer 27 which has a three-layer structure including a quantum well layer interposed between barrier layers. The quantum well layer may comprise an In_{0.2}Ga_{0.8}As material (doped with Si), and may have a thickness of 12 nm and a Si concentration of 5×10¹⁷ cm⁻³. Each of the barrier layers may comprise undoped GaAs_{0.91}P_{0.09} material, and have a thickness of 10 nm. An upper SCH layer 26b comprising undoped Al_{0.2}Ga_{0.8}As material is formed on the active layer 27. The thickness of the upper SCH layer 26b is preferably 50 nm.

Over the upper SCH layer 26b is formed an upper clad layer 28 which comprises p-type Al_{0.3}Ga_{0.7}As material (doped with Zn). Formed on the clad layer 28 is a cap layer 29 which comprises p-type GaAs material (doped with Zn). Specifically, both the upper clad layer 28 and the cap layer 29 are preferably formed in a ridge-like shape, thereby defining a ridge-like optical waveguide extending from the light-emitting end face to the rear face thereof. Here, the cap layer 29 remains only on the upper surface of a ridge-like portion 30. While a mesa ridge structure has been shown to illustrate the present invention, it may be appreciated that other laser structures (such as SAS, buried, etc.) can be used with the present invention.

The thickness of the upper clad layer 28 is preferably 2 μm on the ridge-like portion 30 and 0.9 μm on the other portions. The upper clad layer 28 preferably has a Zn concentration of 3×10¹⁷ cm⁻³. The cap layer 29 preferably has a thickness of 0.5 μm and a Zn concentration of 1×10²⁰ cm⁻³.

Furthermore, an insulating protective film 23 is formed to cover the surfaces of both the upper clad layer 28 and the cap layer 29. In detail, such a protective film 23 is formed with an opening 23A continuously extending from the light-emitting end face to the rear face, over the upper surface of the ridge-like portion 30. The cap layer 29 is exposed on the bottom surface of the opening 23A. Specifically, the protective film 23 is formed by silicon nitride (SiN) having a thickness of 0.12 μm.

An upper electrode 24 is formed to cover the entire surfaces of both the cap layer 29 and the protective film 23 existing on the bottom surface of the opening 23A. In detail, the upper electrode 24 preferably has a three-layer structure including a Ti layer, a Pt layer, and an Au layer laminated successively disposed in this order from the substrate. Specifically, the upper electrode is in ohmic contact with the cap layer 29 on the bottom surface of the opening 23A.

Further, there is also provided a lower electrode 22 covering the bottom surface of the substrate 21. In detail, the lower electrode 22 preferably has two-layer structure including an AuGeNi layer and an Au layer laminated successively in this order from the substrate. Specifically, the lower electrode is in ohmic contact with the substrate 21.

Each of the above compound semiconductor layers may be formed by a known method, such as MOCVD (Metal Organic Chemical Vapor Deposition) and MBE (Molecular Beam Epitaxy). The ridge-like portion 30 is formed by etching the cap layer 29 and the upper clad layer 28 using a citric acid based etchant (an etchant containing a citric acid) while its upper surface is covered by a resist pattern. The protection film 23 comprising silicon nitride may be formed by a reactive sputtering process. The opening 23A may be formed by initially covering the protection layer 23 (except an area forming the opening 23A) with a resist pattern, then etching the protection layer 23 using a hydrofluoric acid based etchant (an etchant containing a hydrofluoric acid). The upper electrode 24 and the lower electrode 22 may be formed by vacuum vapor deposition.

FIG. 3B is a side view illustrating the semiconductor laser device 20 shown in FIG. 3A. As shown in the drawing, a low-reflectivity film 45 is formed on the light-emitting end face 40, while a high-reflectivity film 55 is formed on the rear face 50.

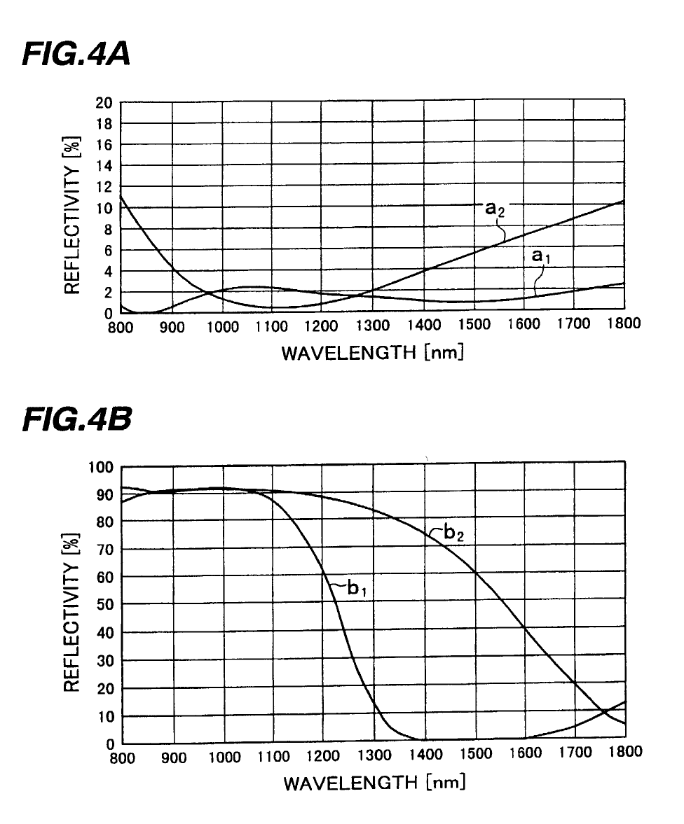

An exemplary laminated structure for the low-reflectivity film 45 will be described first. Namely, an end-face grown film 41 comprising InGaP and having a thickness of 100 nm is grown on the light-emitting end face 40. Formed in tight contact with the end-face grown film 41 are three alternately laminated films including an Al₂O₃ film and an amorphous silicon film. In detail, the first layer is an Al₂O₃ film 42A, the second layer is an amorphous silicon film 43A, and the third layer is an Al₂O₃ film 42B, with the thicknesses of the films being 47.5 nm, 18.9 nm, and 176.7 nm, respectively. In this manner, a low-reflectively film is formed having a first reflectance around 1% at 1.55 μm signal band (less than 2%), and a second reflectance 2% and slightly more at the wavelengths of the pumping bands for EDFA and TDFA. These reflectance values are more fully described below with respect to FIG. 4A. All reflectance values presented and specified herein are in terms of percent of reflected power.

Next, the laminated structure of the high-reflectivity film 55 will be described. Namely, an end-face grown film 51 comprising InGaP and having a thickness of 100 nm is grown on the rear face 50. Formed in tight contact with the end-face grown film 51 are seven alternately laminated films including a SiO₂ film and an amorphous silicon film. First, third, fifth and seventh SiO₂ films 52A, 52B, 52C and 52D have respective thicknesses of 96 nm, 130 nm, 291 nm and 456 nm. Second, fourth and sixth amorphous silicon films 53A, 53B and 53C have respective thicknesses of 66 nm, 57 nm and 10 nm. In this manner, a high-reflectively film is formed having a first reflectance less than 2% at 1.55 μm signal band (and clearly less than 40%), and a second reflectance of over 90% (and clearly over 85%) at the wavelengths of the pumping bands for EDFA and TDFA. These reflectance values are more fully described below with respect to FIG. 4B.

We note here that the reflectance values of the films do not significantly depend upon the direction of the light (e.g., into the laser cavity, out of the laser cavity) when materials having no or low extinction coefficients are used. This is the case for the materials described above for the wavelengths associated with the EDFA and TDFA fiber amplifiers. When using materials with extinction coefficients, there can be a small difference between the reflectance value for light entering the laser cavity and for light exiting the laser cavity. For the purposes of describing and claiming the present invention, we use the average of these two reflectance values when any material having an extinction values greater than 0.01 at the applicable wavelength is used in a film. Otherwise, we will use reflectance values for the direction of light entering the laser cavity. Software programs currently exist for computing reflectance values in both directions given the thicknesses and material properties of the film's layers (including extinction coefficients).

In one constructed embodiment, the end-face grown film 41 is formed by an MOCVD method. The Al₂O₃ film forming the low-reflectivity film 45, as well as the amorphous silicon film, are formed by a CVD method using ECR (Electron Cyclotron Resonance) plasma. The SiO₂ film forming the high-reflectivity film 55, as well as the amorphous silicon film, are formed by using a plasma CVD method. However, the Al₂O₃ film, the amorphous silicon film, and the SiO₂ film can all be formed by sputtering or electron beam vapor deposition.

FIG. 4A is a graph showing how the reflectance of the low-reflectivity film 45 depends on the wavelength of light and how the reflectance of a conventional low-reflectivity film depends on the wavelength of light, thereby showing a comparison between the two dependencies. (The reflectance values are the same for each direction of light propagation.) FIG. 4B is also a graph showing how the reflectance of the high-reflectivity film 55 depends on the wavelength of light and how the reflectance of a conventional high-reflectivity film depends on the wavelength of light, thereby showing a comparison between the two dependencies. (The reflectance values are the same for each direction of light propagation.) In the two graphs, each horizontal axis represents wavelength in the units of nanometers (“nm”), while each vertical axis represents reflectance in the units of percent (“%”) (percent of reflected power). In the graph shown in FIG. 4A, curve a₁ is used to show the reflectance of the low-reflectivity film 45 of the semiconductor laser device according to the present embodiment, while curve a₂ is used to show the reflectance of a conventional low-reflectivity film. In the graph shown in FIG. 4B, curve b₁ is used to show the reflectance of the high-reflectivity film 55 of the semiconductor laser device according to the present embodiment, while curve b₂ is used to show the reflectance of a conventional high-reflectivity film.

The conventional low-reflectivity film (whose reflectance is at curve a₂ shown in FIG. 4A) has a two-layer structure including an end-face grown film consisting of InGaP and having a thickness of 100 nm, as well as an Al₂O₃ film having a thickness of 150 nm to 230 nm. The conventional high-reflectivity film (whose reflectance is shown at curve b₂ in FIG. 4B) has a six-layer structure including (laminated in the following order) an end-face grown film consisting of InGaP and having a thickness of 100 nm, a first SiO₂ film having a thickness of 167 nm, a first amorphous silicon film having a thickness of 71 nm, a second SiO₂ film having a thickness of 167 nm, a second amorphous silicon film having a thickness of 71 nm, and a third SiO₂ film having a thickness of 167 nm.

As shown by curve a₁ in FIG. 4A, the low-reflectivity film 45 for use in the semiconductor laser device according to the present embodiment exhibits a reflectance of about 2% for pumping laser beam having wavelengths at or around the pumping wavelengths of 0.98 μm (EDFA) and 1.060 μm (TDFA), and exhibits a reflectance of about 1% for optical signal having a wavelength of 1.55 μm. As compared with the present embodiment, the conventional low-reflectivity film exhibits a reflectance of about 2% for pumping laser beam having a wavelength of 0.98 μm and a reflectance of about 0.5% for beam having a wavelength of 1.06 μm, but exhibits a reflectance of about 6% for optical signal having a wavelength of 1.55 μm.

As shown in FIG. 4B, the high-reflectivity film for use in the semiconductor laser device formed according to the present embodiment as well as a conventional high-reflectivity film have all been found to exhibit a reflectance as high as about 92% for pumping laser beams having wavelengths at or around the pumping wavelengths of 0.98 μm (EDFA) and 1.06 μm (TDFA). However, with respect to optical signal having a wavelength of 1.55 μm, the high-reflectivity film for use in the semiconductor laser device according to the present embodiment exhibits a reflectance of about 1%, as shown by curve b₁, while the conventional high-reflectivity film exhibits a reflectance of about 50%, as shown by curve b₂. Moreover, the reflectance curve b₁ decreases more rapidly, falling from 85% to 20% within less than 200 nm (e.g., less than 170 nm), whereas curve b₂ does so in 450 nm. Preferred embodiments of the present invention make this transition within 350 nm, and more preferably within 300 nm. It is possible to make this transition with 25 nm with an appropriate selection of layer materials and thicknesses, thereby making the present invention applicable to 1480 nm pumping laser applications. Also in preferred embodiments, there is a local minimum in curve in the wavelength range from 800 nm to 1700 nm, and more preferably within the range of 1300 nm to 1700 nm. (A local minimum is defined where the slope of the curve reaches zero and/or changes sign.)

The advantages of the above embodiment will be described in the following with reference to FIG. 1. As shown in the drawing, the optical signal transmitted through the transmitter-side optical fiber 2 enters the fiber amplifier 3 and is then amplified. At this time, a part of the optical signal is branched at a connection point between the fiber amplifier 3 and the optical fiber 6 so as to be inputted into the pumping laser module 10.

The optical signal inputted into the pumping laser module 10 is reflected on the low-reflectivity film formed on the light-emitting end face (“front facet”) of the semiconductor laser device, and is again introduced into fiber amplifier 3. Further, the optical signal transmitted through the low-reflectivity film is reflected on the high-reflectivity film formed on the rear face of the semiconductor laser device, and is allowed to again transmit through the low-reflectivity film on the light-emitting end face and again enter the fiber amplifier 3. The optical signal again introduced into the fiber amplifier 3 will become a noise component, thus making it difficult to ensure high transmission quality. Although such a noise component is not remarkable when the transmission rate is low, in the case where the transmission rate is high, there is a possibility that the noise component will cause deterioration of transmission quality.

When using the semiconductor laser device according to the present embodiment, in the wavelength range of the optical signal, the low-reflectivity film on the light-emitting end face and the high-reflectivity film on the rear face all have lower reflectances than conventional ones. For this reason, the optical signal reflected by the light-emitting end face, as well as the rear face, and then returning to the fiber amplifier 3 will be reduced in intensity. In this way, it is possible to perform high quality optical transmission with a reduced noise component.

In the present embodiment, although the low-reflectivity film on the light-emitting end face has a reflectance of about 1% in the wavelength ranges of both the pumping laser beam and the optical signal, it is not absolutely necessarily to have the reflectance controlled to 1%. Actually, in order to prevent low transmission quality caused by the returning light from the pumping laser module, it is preferable to have the reflectance in the wavelength range of the optical signal controlled to 2% or lower, and more preferably 0.5% or lower. Further, in order to ensure a sufficient output of the pumping laser, it is preferable to have the reflectance in the wavelength range of the pumping laser beam controlled to 15% or lower.

In general, the reflectance of the low-reflectivity film is designed to be low in the wavelength range of the pumping laser beam. This, however, causes a problem in the conventionally-constructed lasers in that the reflectance will become undesirably high in the wavelength range of the optical signal (such a wavelength range is different from the wavelength range of the pumping laser beam). In the present embodiment of the present invention, the low-reflectivity film is constructed so that its reflectance will become low in the wavelength ranges of both the pumping laser beam and the optical signal. In particular, when the reflectance in the wavelength range of the optical signal is equal to or lower than the reflectance in the wavelength range of the pumping laser beam, reduced transmission quality that is caused by the light returning from the pumping laser module can be effectively reduced.

On the other hand, the reflectance of the high-reflectivity film formed on the rear face of the semiconductor laser is preferably designed to be always 85% or higher (in the wavelength range of the pumping laser beam), so that this reflectance is higher than the reflectance of the low-reflectivity film formed on the light-emitting end face. The inventors have found that the implementation of this objective in conventional laser devices causes the reflectance of the high-reflectivity film to also be high for the wavelength of the optical signal. The inventors have further found that this high reflectivity for the optical signal is undesirable. In the present embodiment, the reflectance of the high-reflectivity film is designed to be high in the wavelength range of the pumping laser beam, but to be low in the wavelength range of the optical signal. Particularly, in order to effectively prevent reduced transmission quality caused by the light returning from the pumping laser module, it is preferable that the reflectance in the wavelength range of the optical signal be controlled to a value of 40% or less, and more preferably to 20% or less, and most preferably to 5% or less. Further, it is also preferable that the reflectance of the high-reflectivity film in the wavelength range of the optical signal be controlled to 1/10 or less of the reflectance in the wavelength range of the pumping laser beam.

Next, a description will be made to explain a method for designing the low-reflectivity film and the high-reflectivity film for use in the semiconductor laser device according to a preferred embodiment of the present invention.

At first, one selects the desired reflectances of the low-reflectivity film and the high-reflectivity film in the wavelength ranges of the optical signal and the pumping laser beam. For example, the desired reflectance of the low-reflectivity film in the wavelength range of the optical signal is set to be 2% or lower, while the desired reflectance of the low-reflectivity film in the wavelength range of the pumping laser beam is set to be 15% or lower. Alternatively, the desired reflectance of the low-reflectivity film in the wavelength range of the optical signal is set to be equal to or lower than the desired reflectance in the wavelength range of the pumping laser beam. Further, the desired reflectance of the high-reflectivity film in the wavelength range of the pumping laser beam is preferably set to be 85% or higher, while the desired reflectance of the high-reflectivity film in the wavelength range of the optical signal is set to be equal to or lower than 1/10 of the desired reflectance in the wavelength range of the pumping laser beam. Alternatively, the desired reflectance of the high-reflectivity film in the wavelength range of the optical signal is set to be 20% or lower, and more preferably to 5% or lower.

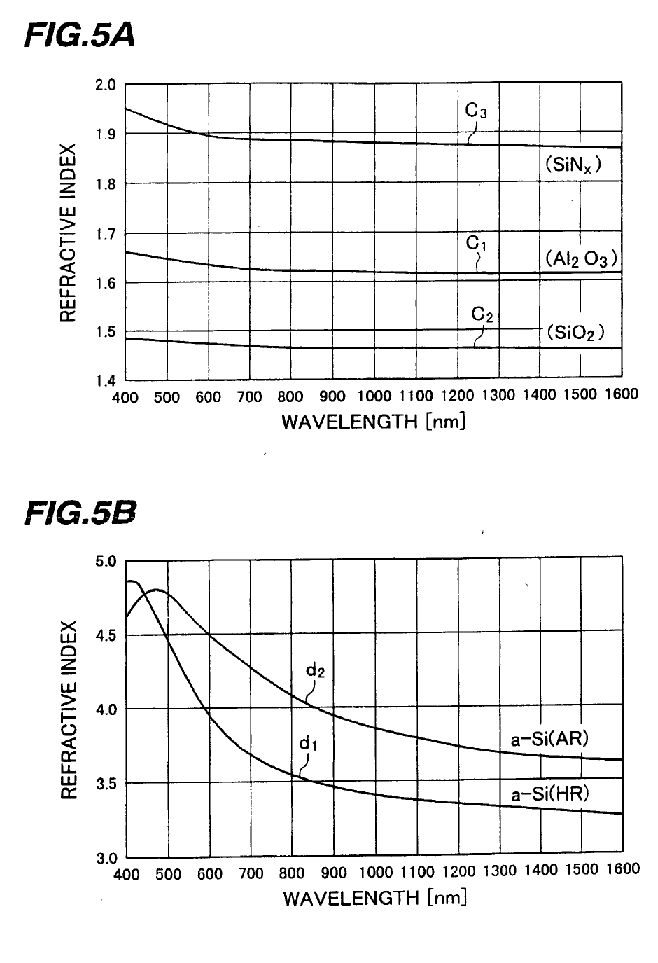

FIG. 5A and FIG. 5B are graphs showing the refractive index of materials of layers constituting the low-reflectivity film and the high-reflectivity film used in the above embodiment. The horizontal axis in each graph is used to represent wavelength in the unit of nanometers (“nm”), while the vertical axis in each graph is used to represent refractive index. Curves c₁ and c₂ in FIG. 5A are used to represent the refractive indexes of the materials of Al₂O₃ and SiO₂, respectively. Curves d₁ and d₂ in FIG. 5B are used to represent the refractive indexes of the amorphous silicon used in the high-reflectivity film and the amorphous silicon used in the low-reflectivity film, respectively. Here, the difference between the refractive index of the amorphous silicon used in the high-reflectivity film and the refractive index of the amorphous silicon used in the low-reflectivity film is due to different film formation methods.

Furthermore, since the refractive index of each material depends upon the film formation method and the film formation conditions, it is preferable that the refractive index of each material formed in a film formation method (to be actually used) under film formation conditions (to be actually used) be measured prior to designing the reflecting film. In this way, if the refractive index of each of the material layers forming the multi-layer reflecting film structure is known, and if the desired reflectances in two wavelength ranges have been determined, it is possible to use known methods to calculate the thickness of each layer of the laminated structure, or to use commercially available software programs. For example, one may use the methods disclosed in Ramo, et al. Fields and Waves in Communication Electronics, second edition, John Wiley & Sons, 1984, pages 285-296.

In the above embodiment, on each of the light-emitting end face and the rear face of the semiconductor laser device, there is formed an end-face grown film comprising InGaP. These end face films are provided to prevent COD (Catastrophic Optical Damage) of the semiconductor laser device. Accordingly, if no COD occurs without the end-face grown films, it is not necessary to provide the end-face grown films.

In the above embodiment, although FIG. 2B shows that the low-reflectivity film 45 may be formed into a multi-layer structure including the end-face grown film 41 and other three layers, it is also possible to change the number of layers.

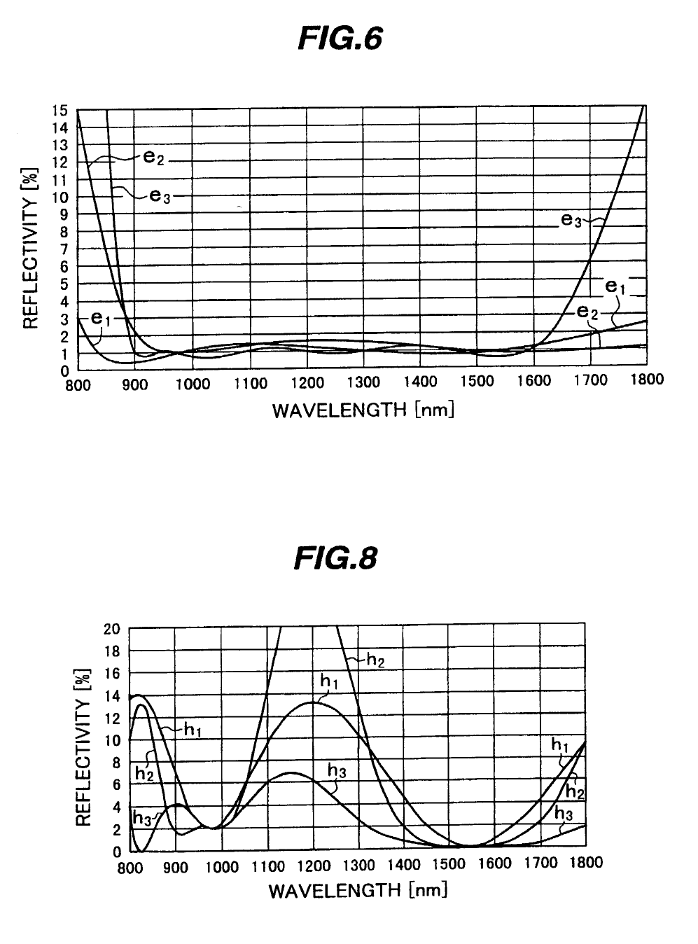

FIG. 6 is a graph showing how the reflectance depends on the wavelength in the case where the number of layers forming the low-reflectivity film has been changed. In the graph, the horizontal axis represents wavelength in the unit of nanometers (“nm”), while the vertical axis represents reflectance in the unit of percent (“%”). Further, curve e₁, curve e₂ and curve e₃ are used to represent the reflectances of a low-reflectivity film when the number of layers forming the low-reflectivity film is three, five, and eight, respectively, excluding the end-face grown film. Namely, curve e₁ is the same as the curve a₁ shown in FIG. 4A.

As may be understood from FIG. 6, when the pumping laser beam has a wavelength of 0.98 μm or 1.06 μm and the optical signal has a wavelength of 1.55 μm, the reflectances will be such that there is no significant difference between a case in which the number of layers, excluding the end-face grown film, is five, eight, or three, the latter of which was provided in the above-described embodiment. For this reason, the above embodiment (0.98 μm/1.06 μm pumping, 1.55 μm signal) has used is a multi-layer structure in which the number of layers, excluding the end-face grown film, is three. On the other hand, when the pumping laser beam as well as the optical signal have different wavelengths from those used in the above-described embodiment, it is preferable to use a multi-layer structure having more than three layers.

Although it has been described in the above embodiment that a multi-layer structure may be formed by the low-reflectivity film 45, the end-face grown film 41, an Al₂O₃ film, and an amorphous silicon film (as shown in FIG. 3B), it is also possible that a multi-layer structure may be formed by some other material films. For example, it is possible to form a multi-layer structure containing a silicon nitride film (SiNₓ) and a SiO₂ film.

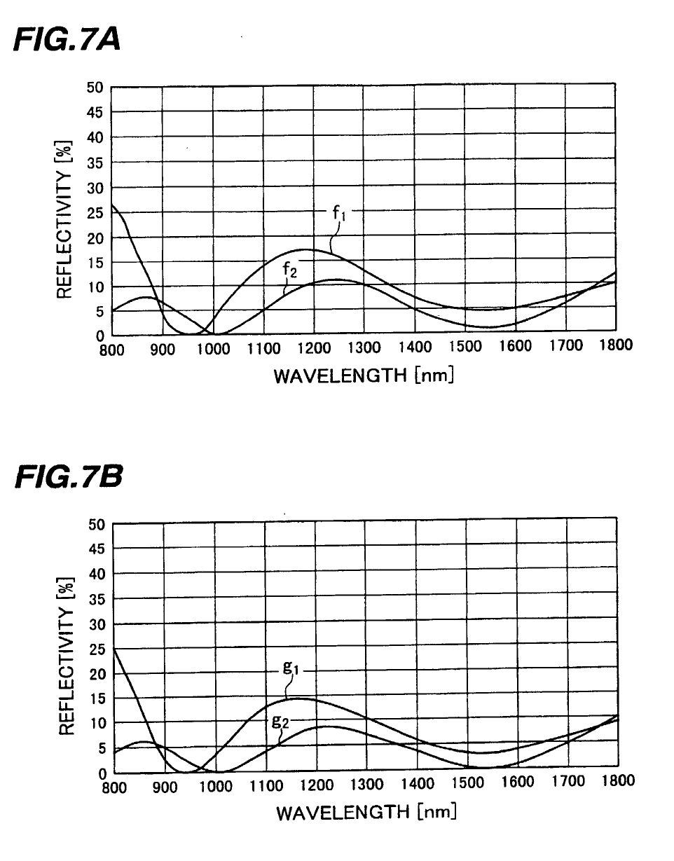

FIG. 7A is a graph showing how the reflectance of a low-reflectivity film (comprising a multi-layer structure including a SiNₓ film and a SiO₂ film) depends on the wavelength of the laser beam. In the graph, the horizontal axis represents wavelength in the unit of nanometers (“nm”), while the vertical axis represents reflectance in the unit of percent (“%”). The refractive index of SiNₓ is shown by a curve c₃ in FIG. 5A. Further, in the graph, curve f₁ represents the reflectance of a low-reflectivity film having a two-layer structure including a SiNₓ film serving as a first layer (having a thickness of 406.78 nm) and a SiO₂ film serving as a second layer (having a thickness of 265.08 nm). Moreover, curve f₂ represents the reflectance of a low-reflectivity film having a four-layer structure including a SiNₓ film serving as a first layer (having a thickness of 181.73 nm), a SiO₂ film serving as a second layer (having a thickness of 63.58 nm), another SiNₓ film serving as a third layer (having a thickness of 329.90 nm), and another SiO₂ film serving as a fourth layer (having a thickness of 156.15 nm). The end-face grown film is not formed, so that the SiNₓ film serving as the first layer is directly formed on the light-emitting end face.

In the above example where the low-reflectivity film has a two-layer structure (curve f₁), the reflectance of the low-reflectivity film is 5% when the optical signal wavelength is in the range of 1.55 μm. However, in the above example where the low-reflectivity film has a four-layer structure (curve f₂), it is possible to reduce such reflectance to about 1%. On the other hand, in the example where the two-layer structure represented by curve f₁ is formed, its reflectance in the wavelength range of the optical signal will be smaller than that of the conventional low-reflectivity film represented by curve a₂ shown in FIG. 4A. For this reason, it is possible to reduce the noise caused by light returning from the pumping laser module.

Further, amorphous silicon absorbs light having a wavelength of 0.98 μm. In an example shown in FIG. 7A, since the material forming the low-reflectivity film does not contain amorphous silicon, it is possible to reduce the loss of the pumping laser beam (which is usually caused due to absorption).

FIG. 7B is a graph showing how the reflectance of a low-reflectivity film (in the case where there is disposed an end-face grown film consisting of InGaP) depends on the wavelength of light. The horizontal axis and the vertical axis are used to represent the same parameters as in FIG. 7A. In detail, curve g₁ and curve g₂ are used to show the reflectances of the low-reflectivity films (in which several layers formed on the respective end-face grown films have the same structure as the several layers represented by curve f₁ and curve f₂ in FIG. 7A). Upon comparison between curves g₁ and g₂ shown in FIG. 7B and curves f₁ and f₂ shown in FIG. 7A, it is understood that the reflectance is substantially unaffected by the end-face grown film. The inventors believe that this is because the index of refraction of the end-face growth film is substantially the same as index of refraction of the material forming the laser cavity.

For use as a reflecting material having the multi-layer structure, it is also possible to use dielectric materials other than the above-described materials. For example, it is possible to employ a laminated structure including a SiNₓ film and a TiO₂ film, as well as another laminated structure including a SiNₓ film and a Ta₂O₅ film.

FIG. 8 is a graph showing reflectances of low-reflectivity films having other laminated structures different from those described in the above. In the graph, the horizontal axis represents wavelength in the unit of nanometers (“nm”), while the vertical axis represents reflectance in the unit of percent (“%”). Further, curve h₁ is used to represent the reflectance of a low-reflectivity film having a five-layer structure formed by using silicon nitride and silicon oxide each serving as a dielectric material. In detail, the first layer is an end-face grown film having a thickness of 100 nm, the second layer is a silicon nitride film having a thickness of 246.6 nm, the third layer is a silicon oxide film having a thickness of 22.9 nm, the fourth layer is a silicon nitride film having a thickness of 295.7 nm, and the fifth layer is a silicon oxide film having a thickness of 133.7 nm.

Further, in the graph, curve h₂ is used to represent the reflectance of a low-reflectivity film having a seven-layer structure formed by using silicon nitride and silicon oxide each serving as a dielectric material. In detail, the first layer is an end-face grown film having a thickness of 100 nm, the second layer is a silicon nitride film having a thickness of 129.1 nm, the third layer is a silicon oxide film having a thickness of 457.6 nm, the fourth layer is a silicon nitride film having a thickness of 114.7 nm, the fifth layer is a silicon oxide film having a thickness of 292.2 nm, the sixth layer is a silicon nitride film having a thickness of 295.5 nm, and the seventh layer is a silicon oxide film having a thickness of 198.8 nm.

Further, curve h₃ is used to represent the reflectance of a low-reflectivity film having a five-layer structure formed by using Ta₂O₅ and silicon oxide each serving as a dielectric material. In detail, the first layer is an end-face grown film having a thickness of 100 nm, the second layer is Ta₂O₅ film having a thickness of 133.6 nm, the third layer is a silicon oxide film having a thickness of 410.5 nm, the fourth layer is Ta₂O₅ film having a thickness of 237.5 nm, and the fifth layer is a silicon oxide film having a thickness of 230.9 nm.

With each of the low-reflectivity films shown in FIG. 8, the reflectance is 0.5% or lower for the optical signal having a wavelength of 1.55 μm, but this reflectance will be about 2% for pumping laser beam having a wavelength of 0.98 μm.

In the above-described embodiment, there is shown an upper limit for a preferable reflectance range of the low-reflectivity film in the semiconductor laser device. Theoretically, it is possible that the reflectance of the low-reflectivity film be 0% with respect to the wavelength of the optical signal. However, it is in fact difficult to make a reflectance of 0% for the wavelength of the optical signal. Actually, in order to ensure an easy design of the semiconductor laser device as well as a high yield for the manufacturing thereof, it is preferable that the lower limit of the reflectance range be 0.01%.

Although the above embodiment uses as an example optical signal having a wavelength of 1.55 μm and a pumping laser beam having a wavelength in the 0.98 μm band or the 1.06 μm band, the above embodiment can also be suitably put into practical use even if the above laser beams have different wavelengths from those described above.

Further Aspects of the Present Invention.

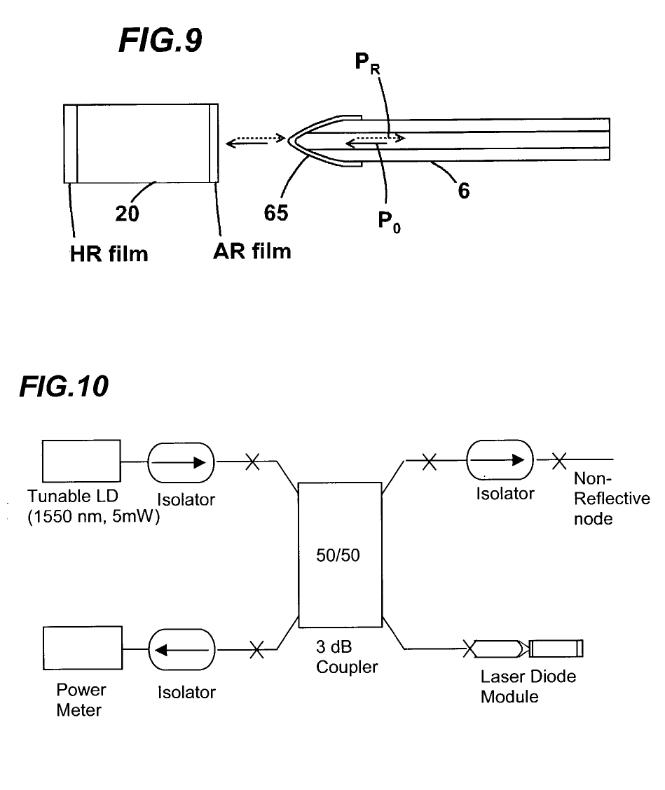

Referring back to FIG. 2, another aspect of the present invention is the provision of an anti-reflective film on the light-incident end face of optical fiber 6 which faces the light emitting end of semiconductor laser 20. This is more clearly shown in FIG. 9 by reference number 65. The film may comprise any number of configuration which reduce the reflectance of the signal light over the case where no film is present. For example anti-reflective film 65 may comprise the following sequence of layers formed over the light-incident face of optical fiber 65: 38.9 nm of Ta₂O₅ (tantalum pentoxide), 55.4 nm of SiO₂ (silicon dioxide), 128.1 nm of Ta₂O₅, and 169.4 nm of SiO₂. This film achieves a reflectivity of 1.12% in band around the wavelength of the optical signal (1550 nm, 1.55 μm). As another example, film 65 may comprise the following sequence of layers formed over the light-incident face of optical fiber 65: 26.1 nm of Ta₂O₅ (tantalum pentoxide), 418.7 nm of SiO₂ (silicon dioxide), 300.4 nm of Ta₂O₅, and 191.4 nm of SiO₂. This film achieves a reflectivity of 0.15% in band around the wavelength of the optical signal (1550 nm). Film 65 reduces the reflectance for the signal light over the case where no anti-reflective film is disposed on the fiber's end. This reflectance is preferably reduced to a value of 2% or less, more preferably 1% or less, and most preferably 0.5% or less and 0.25% or less.

As indicated in FIG. 9, there is an amount of power P₀ of the signal light that comes toward the laser pumping light source 20 from optical fiber 2. A portion of this power is reflected back toward fiber amplifier by HR and AR films of source 20, and the AR film 65 of fiber 6. We denote this reflected power as P_{R}. The amount of noise reduction provided by the present invention can be assessed by the ratio of P_{R}/P₀, which represents the reduction in the amount of returned signal light. This is preferably expressed in units of decibels (dB) based on the following form:

Reduction of Return Light (in dB)=−20 Log₁₀(P_{R}/P₀).

With the present invention, it is quite easy to achieve a 17 dB reduction in the amount of returned signal light, with typical reductions being 18 dB, 20 dB, 22 dB, 24 dB, and 25 dB or more.

The following Table I provides a comparison of reductions in return power for nine exemplary embodiments (examples 1-9) of the present invention and one conventional embodiment (Prior Art). All of the examples have a laser HR reflectivity of about 92% for the pumping light, and a laser AR reflectivity of about 2% for the pumping light. The reflectance values for coating 65 and the AR and HR laser coatings for the nine examples at the wavelength of the optical signal are indicated in the table.

TABLE I

| | Reflectance | Reflectance | Reflectance | Reduction of |
|---|---|---|---|---|
| | of fiber | of Laser's | of Laser's | Return Signal |
| Device | coating 65 | AR coating | HR coating | Power (dB) |
| Prior Art | 4.12% | 10% | 50% | — [11.4] |
| | (no coating) | | | |
| Example 1 | 1.12% | 1% | 50% | — [16.7] |
| Example 2 | 1.12% | 0.5% | 2% | 21.8 [18.9] |
| Example 3 | 0.15% | 1% | 50% | 18.9 [19.3] |
| Example 4 | 0.15% | 0.5% | 2% | 25.9 [25.1] |
| Example 5 | 1.12% | 1% | 40% | — [17.0] |
| Example 6 | 1.12% | 1% | 20% | — [17.7] |
| Example 7 | 1.12% | 1% | 5% | — [18.4] |
| Example 8 | 0.15% | 1% | 20% | — [21.4] |
| Example 9 | 0.15% | 1% | 5% | — [23.2] |

The last column of the table provides both measured and computed values of the reduction in return power. The computed values are show between brackets ([ ]), and are based on a model of the system. As can be seen, values of over 18 dB can be readily obtained, and the best examples achieve reductions of 23 dB to 26 dB.

FIG. 10 shows an exemplary test setup for measuring the reduction in return signal power. A tunable laser diode (1550 nm wavelength, 5 mW power output) is coupled to one of four ports of a 3-dB optical coupler by way of an directional optical coupler, which substantially only allows optical signals in one direction. The 3-dB coupler divides the light equally into two branches that exit on the right side of the coupler. The lower one of these branches is coupled to the laser diode module under test, while the upper one is coupled to a non-reflective node through another isolator. Half of the output power of the tunable laser diode is provided to the module under test. Reflected light from the module under test is coupled back to the left branches in divided and equal amounts (50-50). A power meter is coupled to the lower branch through another optical isolator. Half of the power reflected by the module under test is provided to the power meter. The “X” symbols in the figure indicate where melt point connections have been made. The reduction in return signal power may be computed by setting P_{R} equal to twice the value of the reading on the power meter, and setting P₀ equal to one-half of the output power level of the tunable laser diode. Adjustments to these values may be done to account for any known power losses in the 3-dB coupler and optical isolators. The quantity −20 Log10(P_{R}/P₀) may then be evaluated to obtain the reduction value. The value P₀ of may also be obtained by coupling the power meter to the lower right branch of the 3-dB coupler, either before or after the module under test is coupled to the branch.

Although the present invention has been described in line with the above embodiments, it should be understood that the present invention should not be limited to such a specific examples. For example, based on the teaching of the present application, it is clear that a person of ordinary skill in the art can make various modifications, improvements, and combinations without departing from the scope of the present invention.

What is claimed is:

1. An optical transmission apparatus for amplifying an optical signal having a first wavelength, as measured in free-space, the optical transmission apparatus comprising:
an optical fiber amplifier having first end to receive the optical signal and a second end to output an amplified version of the optical signal; and
a laser pumping light source adapted to generate a pumping laser beam having a second wavelength, as measured in free-space, which is different from the first wavelength, the pumping laser beam being optically coupled to at least one of the ends of the optical fiber amplifier, the laser pumping light source comprising a front facet to output the pumping laser beam, a rear facet, a resonator cavity disposed between the front and rear facets, a high-reflectivity film formed on the rear face, the high-reflectivity film having a first reflectance for light of the first wavelength and a second reflectance for light of the second wavelength, wherein the first reflectance of high-reflectivity film has a value of 40% or less.

2. An optical transmission apparatus according to claim 1, wherein the first reflectance of the high-reflectivity film is 1/10 or less of the second reflectance of the high-reflectivity film.

3. An optical transmission apparatus according to claim 1, wherein the first reflectance of high-reflectivity has a value of 20% or less.

4. An optical transmission apparatus according to claim 1, wherein the first reflectance of high-reflectivity has a value of 5% or less.

5. An optical transmission apparatus according to claim 1, wherein the first wavelength is within 100 nm of 1.55 μm, and wherein the second wavelength is within 30 nm of 0.98 μm.

6. An optical transmission apparatus according to claim 1, wherein the first wavelength is within 100 nm of 1.55 μm, and wherein the second wavelength is within 60 nm of 1.06 μm.

7. An optical transmission apparatus according to claim 1, wherein ratio of the first wavelength to the second wavelength is at least 1.35.

8. An optical transmission apparatus according to claim 1, wherein first wavelength is 300 nm or more than the second wavelength.

9. An optical transmission apparatus according to claim 1, wherein the laser pumping light source further comprises a low-reflectivity film disposed at the front facet, the low-reflectivity film having a first reflectance of 2% or less for light of the first wavelength, and a second reflectance of 15% or less for light of the second wavelength.

10. An optical transmission apparatus according to claim 1, wherein the laser pumping light source further comprises a low-reflectivity film disposed at the front facet, the low-reflectivity film having a first reflectance for light of the first wavelength and a second reflectance for light of the second wavelength, wherein the first reflectance of the low-reflectivity film is equal to or less than the second reflectance of the low-reflectivity film.

11. An optical transmission apparatus according to claim 1, wherein the laser pumping light source further comprises a low-reflectivity film disposed at the front facet, the low-reflectivity film having a first reflectance for light of the first wavelength and a second reflectance for light of the second wavelength, wherein the second reflectance of the high-reflectivity film is greater than the second reflectance of the low-reflectivity film.

12. An optical transmission apparatus according to claim 1, further comprising an optical fiber for conveying pumping light from the laser pumping light source to the optical fiber amplifier, the optical fiber having an end disposed at the front facet of the laser pumping light source and an anti-reflective film disposed on the fiber's end which reduces the reflectance for light of the first wavelength over the case where no anti-reflective film is disposed on the fiber's end.

13. An optical transmission apparatus according to claim 12, wherein the anti-reflective film disposed on the fiber's end has a reflectance of 2% or less for light of the first wavelength.

14. An optical transmission apparatus according to claim 12, wherein the anti-reflective film disposed on the fiber's end has a reflectance of 1% or less for light of the first wavelength.

15. The optical transmission apparatus according to claim 12, wherein the fiber amplifier directs a first amount of the optical signal having a power P₀ through the optical fiber toward the laser pumping light source;
wherein a second amount of the optical signal having power P_{R} is returned back through the optical fiber toward the fiber amplifier; and
wherein the amount of returned light is reduced by at least 17 decibels, wherein the reduction in decibels is defined by the quantity −20 Log₁₀(P_{R}/P₀).

16. An optical transmission apparatus according to claim 15, wherein amount of returned light is reduced by at least 20 decibels.

17. An optical transmission apparatus for amplifying an optical signal having a first wavelength, as measured in free-space, the optical transmission apparatus comprising:
an optical fiber amplifier having first end to receive the optical signal and a second end to output an amplified version of the optical signal;
a laser pumping light source adapted to generate a pumping laser beam having a second wavelength, as measured in free-space, which is different from the first wavelength, the pumping laser beam being optically coupled to at least one of the ends of the optical fiber amplifier, the laser pumping light source comprising a front facet to output the pumping laser beam, a rear facet, a resonator cavity disposed between the front and rear facets, a high-reflectivity film formed on the rear face, the high-reflectivity film having a first reflectance for light of the first wavelength and a second reflectance for light of the second wavelength, a low-reflectivity film disposed at the front facet, the low-reflectivity film having a first reflectance for light of the first wavelength and a second reflectance for light of the second wavelength;
an optical fiber for conveying pumping light from the laser pumping light source to the optical fiber amplifier, the optical fiber having an end disposed at the front facet of the laser pumping light source, and
wherein the fiber amplifier directs a first amount of the optical signal having a power P₀ through the optical fiber toward the laser pumping light source;
wherein a second amount of the optical signal having power P_{R} is returned back through the optical fiber toward the fiber amplifier, the second amount being generated in part from the laser pumping light source; and
wherein the amount of returned light is reduced by at least 17 decibels, wherein the reduction in decibels is defined by the quantity −20 Log₁₀(P_{R}/P₀).

18. An optical transmission apparatus according to claim 17, wherein amount of returned light is reduced by at least 18 decibels.

19. An optical transmission apparatus according to claim 17, wherein amount of returned light is reduced by at least 20 decibels.

20. An optical transmission apparatus according to claim 17, wherein amount of returned light is reduced by at least 24 decibels.

21. A semiconductor pumping laser device for use in amplifying an optical signal having a first wavelength, as measured in free-space, the semiconductor pumping laser device generating a pumping laser beam having a second wavelength, as measured in free-space, the second wavelength being different from the first wavelength, the semiconductor pumping laser device comprising:
a front facet to output the pumping laser beam, a rear facet, a resonator cavity disposed between the front and rear facets;
a semiconductor laminated structure comprising an active layer disposed within at least the resonator cavity and constructed to generate light having the second wavelength, and
a high-reflectivity film formed on the rear face, the high-reflectivity film having a first reflectance for light of the first wavelength and a second reflectance for light of the second wavelength, wherein the first reflectance of high-reflectivity film has a value of 40% or less,
wherein the first wavelength and the second wavelength are within the signal band and pumping band, respectively, of an optical fiber amplifier.

22. An optical transmission apparatus according to claim 21, wherein the first reflectance of the high-reflectivity film is 1/10 or less of the second reflectance of the high-reflectivity film.

23. An optical transmission apparatus according to claim 21, wherein the first reflectance of high-reflectivity has a value of 20% or less.

24. An optical transmission apparatus according to claim 21, wherein the first reflectance of high-reflectivity has a value of 5% or less.

25. An optical transmission apparatus according to claim 21, wherein the first wavelength is within 100 nm of 1.55 μm, and wherein the second wavelength is within 30 nm of 0.98 μm.

26. An optical transmission apparatus according to claim 21, wherein the first wavelength is within 100 nm of 1.55 μm, and wherein the second wavelength is within 60 nm of 1.06 μm.

27. An optical transmission apparatus according to claim 21, wherein ratio of the first wavelength to the second wavelength is at least 1.35.

28. An optical transmission apparatus according to claim 21, wherein first wavelength is 300 nm or more than the second wavelength.

29. An optical transmission apparatus according to claim 21, wherein the laser pumping light source further comprises a low-reflectivity film disposed at the front facet, the low-reflectivity film having a first reflectance of 2% or less for light of the first wavelength, and a second reflectance of 15% or less for light of the second wavelength.

30. An optical transmission apparatus according to claim 21, wherein the laser pumping light source further comprises a low-reflectivity film disposed at the front facet, the low-reflectivity film having a first reflectance for light of the first wavelength and a second reflectance for light of the second wavelength, wherein the first reflectance of the low-reflectivity film is equal to or less than the second reflectance of the low-reflectivity film.

31. An optical transmission apparatus according to claim 21, wherein the laser pumping light source further comprises a low-reflectivity film disposed at the front facet, the low-reflectivity film having a first reflectance for light of the first wavelength and a second reflectance for light of the second wavelength, wherein the second reflectance of the high-reflectivity film is greater than the second reflectance of the low-reflectivity film.

32. An optical transmission apparatus according to claim 21, further comprising an optical fiber for conveying pumping light from the laser pumping light source to the optical fiber amplifier, the optical fiber having an end disposed at the front facet of the laser pumping light source and an anti-reflective film disposed on the fiber's end which reduces the reflectance for light of the first wavelength over the case where no anti-reflective film is disposed on the fiber's end.

33. An optical transmission apparatus according to claim 32, wherein the anti-reflective film disposed on the fiber's end has a reflectance of 2% or less for light of the first wavelength.

34. An optical transmission apparatus according to claim 32, wherein the anti-reflective film disposed on the fiber's end has a reflectance of 1% or less for light of the first wavelength.

35. The optical transmission apparatus according to claim 32, wherein the fiber amplifier directs a first amount of the optical signal having a power P₀ through the optical fiber toward the laser pumping light source;
wherein a second amount of the optical signal having power P_{R} is returned back through the optical fiber toward the fiber amplifier; and
wherein the amount of returned light is reduced by at least 17 decibels, wherein the reduction in decibels is defined by the quantity −20 Log₁₀(P_{R}/P₀).

36. A semiconductor pumping laser device according to claim 21, wherein the reflectivity curve for light exiting the rear facet versus wavelength comprises at least one local minimum in the range of wavelengths from 800 nm to 1700 nm.

37. A semiconductor laser device for use with an optical signal having a first wavelength, as measured in free-space, the semiconductor laser device generating a laser beam having a second wavelength, as measured in free-space, the second wavelength being different from the first wavelength, the semiconductor laser device comprising:
a front facet to output the laser beam, a rear facet, a resonator cavity disposed between the front and rear facets;
a semiconductor laminated structure comprising an active layer disposed within at least the resonator cavity and constructed to generate light having the second wavelength, and
a high-reflectivity film formed on the rear face, the high-reflectivity film having a first reflectance for light of the first wavelength and a second reflectance for light of the second wavelength,
a low-reflectivity film disposed at the front facet, the low-reflectivity film having a first reflectance for light of the first wavelength and a second reflectance for light of the second wavelength;
an optical fiber having an end disposed at the front facet, and
wherein incoming light of the first wavelength having a power level P₀ and being conveyed through the optical fiber toward the front facet is reflected back through the optical fiber away from the front facet at a power level P_{R}, wherein the return power level P_{R} is reduced with respect to the incoming power level P₀ by at least 17 decibels, wherein the reduction in decibels is defined by the quantity −20 Log₁₀(P_{R}/P₀).

38. A semiconductor laser device according to claim 37, wherein the return power level P_{R} is reduced with respect to the incoming power level P₀ by at least 18 decibels.

39. A semiconductor laser device according to claim 37, wherein the return power level P_{R} is reduced with respect to the incoming power level P₀ by at least 20 decibels.

40. A semiconductor laser device according to claim 37, wherein the return power level P_{R} is reduced with respect to the incoming power level P₀ by at least 24 decibels.

41. A semiconductor laser device for use with an optical signal having a first wavelength, as measured in free-space, the semiconductor laser device generating a laser beam having a second wavelength, as measured in free-space, the second wavelength being different from the first wavelength, the semiconductor laser device comprising:
a front facet to output the laser beam, a rear facet, a resonator cavity disposed between the front and rear facets;
a semiconductor laminated structure comprising an active layer disposed within at least the resonator cavity and constructed to generate light having the second wavelength, and
a low-reflectivity film disposed at the front facet, the low-reflectivity film having a first reflectance for light of the first wavelength and a second reflectance for light of the second wavelength, the first reflectance having a value of 2% or less;
an optical fiber having an end disposed at the front facet and an anti-reflective film disposed on the fiber's end which reduces the reflectance for light of the first wavelength over the case where no anti-reflective film is disposed on the fiber's end.

42. An optical transmission apparatus according to claim 41, wherein the anti-reflective film disposed on the fiber's end has a reflectance of 2% or less for light of the first wavelength.

43. An optical transmission apparatus according to claim 41, wherein the anti-reflective film disposed on the fiber's end has a reflectance of 0.5% or less for light of the first wavelength.

44. An optical transmission apparatus according to claim 41, wherein the first reflectance of the low-reflectivity film has a value of 1% or less.

45. An optical transmission apparatus according to claim 43, wherein the first reflectance of the low-reflectivity film has a value of 1% or less.

46. An optical transmission apparatus according to claim 43, wherein the first reflectance of the low-reflectivity film has a value of 0.5% or less.

47. A method of manufacturing a semiconductor laser device for introducing a pumping laser beam having a second wavelength, as measured in free space, into an optical fiber amplifier capable of amplifying optical signal having a first wavelength, as measured in free space, the second wavelength being different from the first wavelength, said method comprising the steps of:
forming a semiconductor laser laminated structure defining a light-emitting end face and a rear face, said laminated structure being capable of effecting a stimulated emission by injecting carriers, and emitting from the light-emitting end face the pumping laser beam having the second wavelength;
forming a low-reflectivity film on the light-emitting end face having a first reflectance for light of the first wavelength and a second reflectance for light of the second wavelength; and
forming a high-reflectivity film on the rear face having a first reflectance for light of the first wavelength and a second reflectance for light of the second wavelength, the first reflectance of said high-reflectivity film having a value of 40% or less.

48. A method according to claim 47, wherein the first reflectance of the high-reflectivity film is 1/10 or less of the second reflectance of the high-reflectivity film.

49. A method according to claim 47, wherein the first reflectance of high-reflectivity has a value of 20% or less.

50. A method according to claim 47, wherein the first reflectance of high-reflectivity has a value of 5% or less.

51. A method according to claim 47, wherein the first wavelength is within 30 nm of 0.98 μm, and wherein the second wavelength is within 100 nm of 1.55 μm.

52. A method according to claim 47, wherein the first wavelength is within 60 nm of 1.06 μm, and wherein the second wavelength is within 100 nm of 1.55 μm.

53. A method according to claim 47, wherein ratio of the first wavelength to the second wavelength is at least 1.35.

54. A method according to claim 47, wherein first wavelength is 300 nm or more than the second wavelength.

55. A method according to claim 47, wherein the first reflectance of the low-reflectivity film is 2% or less, and the second reflectance of the low-reflectivity film is 15% or less.

56. A method according to claim 47, wherein the first reflectance of the low-reflectivity film is equal to or less than the second reflectance of the low-reflectivity film.

57. A method according to claim 47, wherein the second reflectance of the high-reflectivity film is greater than the second reflectance of the low-reflectivity film.
